(19) United States
(12) Patent Application Publication
(10) Pub. No.: US 2014/0304683 A1
(43) Pub. Date: Oct. 9, 2014

(54) METHOD, SERVER AND COMPUTER-READABLE RECORDING MEDIA FOR MANAGING METASTORE

(71) Applicant: Obigo Inc., Gyeonggi-do (KR)

(72) Inventors: Il Hwan Kim, Gyeonggi-do (KR); Jung Yun Kwon, Seoul (KR); Ju Ho Chung, Gyeonggi-do (KR); Han Chul Kim, Seoul (KR)

(73) Assignee: Obigo Inc., Gyeonggi-do (KR)

(21) Appl. No.: 14/243,052

(22) Filed: Apr. 2, 2014

(30) Foreign Application Priority Data
Apr. 8, 2013 (KR) 10-2013-0038092
May 30, 2013 (KR) 10-2013-0062057

(51) Int. Cl. G06F 9/44

(52) U.S. Cl. CPC G06F 8/71
USPC 717/121

(57) ABSTRACT

A method for managing a metastore includes steps of: (a) registering static resource and metadata at a metastore to produce a certain application by using an open device API and external HTML5 authoring tools; (b) configuring a build target operating system and a build target platform; (c) checking a degree of matching between i) the static resource and the metadata and ii) information on parameters delivered from a build target metarepository by referring to the configured build target operating system and platform; (d) calling an external open build system and an API, if the degree of matching is satisfied, and then creating and receiving a target executable file in return to fit for the configured build target operating system and platform; and (e) storing the target executable file, the static resource and the metadata in a metasource repository.

### CROSS REFERENCE TO RELATED APPLICATIONS

This application is claiming the Convention priority date of Apr. 8, 2013, based on Korean Patent Application No. 10-2013-0038092 and claiming the Convention priority date of May 30, 2013, based on Korean Patent Application No. 10-2013-0062057, all incorporated herein by reference.

### FIELD OF THE INVENTION

The present invention relates to a method, a server, and a computer-readable recording media for managing metastore; and more particularly, to the method, the server, and the computer-readable recording medium for managing the metastore under which static resource and metadata is registered to produce a certain application by using open device APIs and external HTML5 authoring tools, and, if degree of matching between (i) the static resource and the metadata and (ii) information on parameters received from a build target metadata repository is satisfied by referring to the configured operating system and platform, a target executable file is created and then returned to fit for a configured operating system and platform by calling an external open build system and an API and the resource and the metadata is stored and registered in a metasource repository with the target executable file.

### BACKGROUND OF THE INVENTION

With the wide spread of smart phones, various types of applications have been developed in an open environment and have been rapidly spread. In general, online open market systems are classified into a developer portal and a buyer portal. In detail, the online open market means a virtual market for providing infrastructure in which developers register and price their developed applications in the developer portal and buyers search, purchase and download such applications in the buyer portal. The online open markets provide a function of supporting, verifying, distributing and compiling statistics on the developments for the developers and a course of searching, purchasing, and installing contents fit for the buyer's terminals.

Distributing a variety of applications developed as such through the open market is a kind of commercial transaction in all mobile platforms including Android Market, and Windows Marketplace starting from Apple's App Store. Service providers such as Amazon or SK Telecom which are not platform owners are advancing into businesses for operating third party markets.

Korean Laid-Open Publication No. 10-2011-0066274 relates to an open marketplace system and an open marketplace server and a method for providing applications by using them. By including a developer portal which provides development tools required for developing applications to developers and in which the developers register their developed applications; a test bed where the registered applications are tested; and a buyer portal where the completely tested applications at the test bed are sold to purchasers, the open marketplace server offers the applications to which reliable test has been applied. Even under Korean Laid-Open Publication No. 10-2011-0066274, because different markets have different operating systems and platforms, developers need to develop applications by running a separate build by platform and register them separately to each market.

### SUMMARY OF THE INVENTION

It is an object of the present invention to solve the problems mentioned above.

It is the other object of the present invention to process a series of courses of not only managing a certain application in a metastore but also registering it by registering static resource and metadata in the metastore to produce the application, receiving a target executable file which corresponds to a configured target operating system and platform from an external open build system, and managing the target executable file to be interlocked with multiple open markets. Accordingly, the present invention may resolve troubles which include creating separate executable files according to each operating system and platform and registering the created executable file separately depending on each market.

In accordance with one aspect of the present invention, there is provided a method for managing a metastore, including steps of: (a) registering static resource and metadata at a metastore to produce a certain application by using an open device API and external HTML5 authoring tools; (b) configuring a build target operating system and a build target platform; (c) checking a degree of matching between i) the static resource and the metadata and ii) information on parameters delivered from a build target metarepository by referring to the configured build target operating system and platform; (d) calling an external open build system and an API, if the degree of matching is satisfied, and then creating and receiving a target executable file in return to fit for the configured build target operating system and platform; and (e) storing the target executable file, the static resource and the metadata in a metasource repository.

In accordance with one aspect of the present invention, there is provided a server for managing a metastore, including: (a) a static resource and metadata registering part for registering static resource and metadata at a metastore to produce a certain application by using open device APIs and external HTML5 authoring tools; and (b) a target executable file creating part for checking a degree of matching between i) the static resource and the metadata and ii) information on parameters delivered from a build target metarepository by referring to a build target operating system and a build target platform if being configured, calling an external open build system and an API, creating and receiving a target executable file in return to fit for the configured build target operating system and platform and then storing the target executable file, the static resource and the metadata in a metasource repository.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing to explain a whole system for producing and managing an application corresponding to each operating system and platform by using a metastore and registering it to external open markets in accordance with an example embodiment of the present invention.

FIG. 2 is a diagram representing the configuration of a server for managing the metastore in accordance with an example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The apparatus for transferring substrates in accordance with example embodiments of the present invention by referring to attached diagrams will be explained in detail as follows:

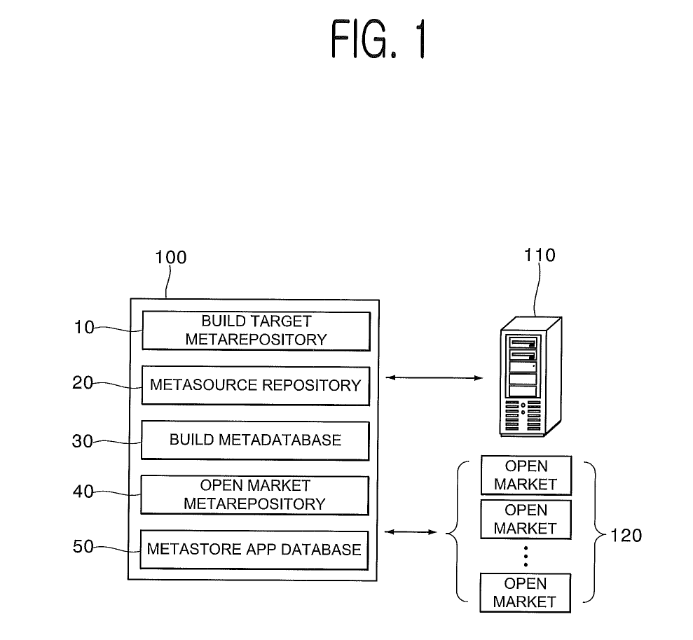

FIG. 1 is a drawing to explain a whole system for producing and managing an application corresponding to each operating system and platform by using a metastore and registering it to external open markets in accordance with an example embodiment of the present invention.

The whole system includes a metastore 100, an external open build system 110, and multiple external open markets 120. The metastore 100 may communicate with the external open build system 110 and the multiple external open markets 120 by using a communication network. In accordance with one embodiment of the present invention, the communication network may be configured regardless of wired or wireless and may be configured in a form of a wide area network (WAN), a local area network (LAN), a mobile telecommunication network, an artificial satellite network, and other various networks. More specifically, the communication network referred to in the present invention may include wireless telecommunication networks implemented by technologies such as IEEE 802.11, Code Division Multiple Access (CDMA), Wideband Code Division Multiple Access (WCDMA), Global System for Mobile communications (GSM), or Long Term Evolution (LTE). However, the communication network may include, but may not be limited to, at least a wired and wireless data communication network, a telephone network, or a wired or wireless network for televisions known to the public.

In accordance with an example embodiment of the present invention, the external open build system 110 stores and manages an application programming interface (API) fit for multiple target operating systems and platforms and performs a function of providing a prefixed API if being requested by the metastore 100. The metastore 100 may create a target executable file on the basis of static resource and metadata by calling the external open build system 110.

Next, the external open markets 120 in accordance with an example embodiment of the present invention are online space in which external developers develop a variety of services including games based on the platforms and service infrastructure and the developed services are allowed to be published for users to select one of them. For example, App Store, OpenAppMkt, Olleh Market and the like may be included. The target executable file created in the metastore 100 may be interlocked with the external open markets 120.

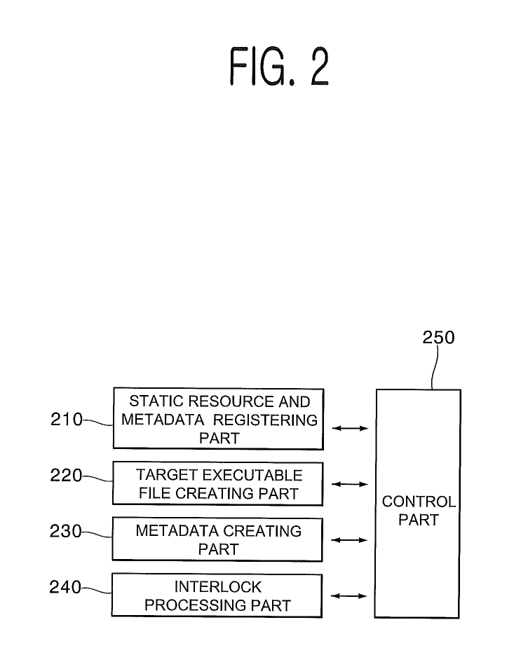

In accordance with an example embodiment of the present invention, the metastore 100 may include a build target metarepository 10, a metasource repository 20, a build metadatabase 30, an open market metarepository 40, a metastore app database 50 and the like. The function of the above-mentioned respective elements in the metastore 100 may be controlled by a server for managing the metastore 100. By referring to FIG. 2, the metastore 100 will be more specifically explained below.

FIG. 2 is a diagram representing the configuration of a server for managing the metastore in accordance with an example embodiment of the present invention.

By referring to FIG. 2, the server of managing the metastore 100 includes a static resource and metadata registering part 210, a target executable file creating part 220, a metadata creating part 230, an interlock processing part 240 and a control part 250. In accordance with one embodiment of the present invention, at least some of the static resource and metadata registering part 210, the target executable file creating part 220, the metadata creating part 230, the interlock processing part 240 and the control part 250 may be program modules communicating with an external device. Such program modules may be included in a form of an operating system, an application program module and other program modules, or they may be stored physically in various storage devices well known to those skilled in the art. In addition, such program modules may be stored in a remote storage device capable of communicating with the server. The program modules may include but not be subject to a routine, a subroutine, a program, an object, a component, and a data structure for executing a specific operation or a type of specific abstract data that will be described in accordance with the present invention.

The static resource and metadata registering part 210 performs a function of allowing static resource and metadata to be registered. The registered static resource and metadata may be used to produce a specific application by using an open device API and an external HTML5 authoring tool. At the time, the static resource may be at least one of Hypertext Markup Language (HTML), Image or JavaScript, and the metadata may be at least either eXtensible Markup Language (XML) or JavaScript Standard Object Notation (JSON). At the time, the external HTML5 authoring tool may automatically provide a RESTful API that may process information on the metadata a developer of the specific application intends to register.

Next, the target executable file creating part 220 performs a function of creating a target executable file by using static resource and metadata registered in the metastore 100 by the static resource and metadata registering part 210.

By referring to information on an operating system and platform to be built if being selected among multiple operating systems and platforms, the target executable file creating part 220 first checks a degree of matching between i) the static resource/the metadata and ii) parameter information delivered from the build target metarepository 10. Because the required parameter information at build time is different by platform, the parameter information corresponding to the selected target operating system and platform may be received from the build target metarepository 10. The target executable file creating part 220 may check the degree of matching by checking the occurrence of an error between i) the static resource/the metadata and ii) the parameter information delivered from the build target metarepository 10. Furthermore, in order to check the degree of matching in case the metadata is from a composite application, not only a course of checking the degree of matching between i) the static resource/the metadata and ii) the parameter information delivered from the build target metarepository 10 but also either a course of checking a degree of matching by referring to association between the composite application and a seed application which is component of the composite application or a course of confirming information on the existence of the seed application, the number of the seed application, the number of the composite application, the version of the composite application and the like may be further performed.

The parameter information, used to check the degree of matching, delivered from the build target metarepository 10 may include at least any piece of information on an app title, a method for creating an app, a platform as an app build environment, an app version, a description, a key to be used at each platform, an app package, a debug mode, or a disclosure of download.

Next, if the degree of matching is satisfied, the target executable file creating part 220 calls the external open build system 110 and an API. When the target executable file which is built to fit for the build target operating system and platform determined by the external open build system 110 and the API is created, the target executable file creating part 220 gets it in return and then allow the returned target executable fie to be stored and registered in the metasource repository 20 with the static resource and the metadata.

At the time, to obtain the target executable file by configuring the operating system and platform other than those configured initially, the target executable file creating part 220 may obtain the static resource and the metadata from the metasource repository 20, and store the target executable file in return corresponding to the newly configured target operating system and platform through the previously commented course in the metasource repository 20. In other words, in accordance with an example embodiment of the present invention, it may easily manage the executable files for various operating systems and platforms by managing the returned executable file corresponding to the configured target operating system and platform through the external open build system 110 after storing the static resource and the metadata to produce a certain application.

Thereafter, the metadata creating part 230 in accordance with an example embodiment of the present invention performs a function of creating the metadata for store to register the target executable file stored in the metasource repository 20 at external open markets. At the time, if a market to register the target executable file among multiple external open markets is selected, the information corresponding to the selected open market may be matched with information received from a build metadatabase part 30 and the open market metarepository 40 to thereby create the metadata for store corresponding to the selected market. At the time, the open market metarepository 40 may include information on a developer of a certain application, charged or free service if being used, information on a category of the application as well as information on multiple operating systems, platforms, browsers, markets, market registration and meta information properties, and the created metadata for store may be stored in a metadata app database 50. Besides, it has been explained in this specification in accordance with an example embodiment of the present invention that the metadata for store for the target executable file in the metastore 100 is created, but it is not limited to this and the metadata for store may be created as well by receiving the executable file created externally other than the created target executable file at the metastore 100 in accordance with an example embodiment of the present invention.

Next, when the metadata for the store is created from the metadata creating part 230, the interlock processing part 240 calls an API for registering and managing external open markets from the external open markets 120. By using the API, it may process to interlock the metadata for store and the target executable file with the external open markets 120. Accordingly, the certain application may be registered not only at the metastore 100 but also at the multiple external open markets 120. In other words, in accordance with one example embodiment of the present invention, it may manage the target executable file processed which is built by referring to respective operating systems and platforms and may process a series of functions of registering and managing applications directly not only at the metastore 100 but also at various external open markets through the interlock therewith.

Lastly, the control part 250 in accordance with an example embodiment of the present invention controls the flow of data among the static resource and metadata registering part 210, the target executable file creating part 220, the metadata creating part 230, and the interlock processing part 240, and the control part 250 may allows the static resource and metadata registering part 210, the target executable file creating part 220, the metadata creating part 230, and the interlock processing part 240 to perform their unique functions. In addition, if a certain application is registered to the external open markets 120, and then information on the sales record, review or registered developer of the registered application at the multiple external open markets 120 is processed by using a prefixed API, the contents may be managed.

In accordance with the present invention, a series of courses of managing a certain application at metastore as well as interlocking it with various external open markets to register it at a time is allowed by registering static resource and metadata to produce the certain application, receiving a target executable file from an external open build system to meet a configured target operating system and platform, managing the target executable file corresponding to the target operating system and platform at each external open market and interlocking it with multiple external open markets. Accordingly, the present invention may resolve the problem of creating each separate executable file by operating system and platform and separately registering the created file.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variation equal or equivalent to the patent claims pertain to the category of the thought of the present invention.

What is claimed is:

1. A method for managing a metastore, comprising steps of:
(a) registering static resource and metadata at a metastore to produce a certain application by using an open device API and external HTML5 authoring tools;
(b) configuring a build target operating system and a build target platform;
(c) checking a degree of matching between i) the static resource and the metadata and ii) information on parameters delivered from a build target metarepository by referring to the configured build target operating system and platform;
(d) calling an external open build system and an API, if the degree of matching is satisfied, and then creating and receiving a target executable file in return to fit for the configured build target operating system and platform; and
(e) storing the target executable file, the static resource and the metadata in a metasource repository.

2. The method of claim 1, wherein step (c) is performed by checking occurrence of any error between i) the static resource and the metadata and ii) the information on parameters delivered from the build target metarepository.

3. The method of claim 1, wherein, if the metadata is of a composite application, the step (c) further includes a step of checking a degree of matching between the composite application and its seed application.

4. The method of claim 1, wherein, if another build target operating system and another build target platform are configured in addition to those configured at the step (b), the steps (c) to (e) are performed after the static resource and the metadata are obtained from the metasource repository.

5. The method of claim 1, wherein the static resource includes at least one of HTML, Image or JavaScript.

6. The method of claim 1, wherein the metadata is either XML or Json.

7. The method of claim 1, wherein the parameter information includes at least one piece of information on an app title, a method for creating an app, classification of an app build environment, an app version, explanation, keys to be used for each platform, an app package, a debug mode, and a download disclosure.

8. The method of claim 1, further comprising a step of (f) creating a metadata for store corresponding to one of multiple open markets where the target executable file will be registered by matching required information between an open market metadata repository and a build metadatabase to check a condition to register in a market after the market is selected among a plurality of open markets.

9. The method of claim 8, wherein the metadata for store created from the step (f) and the target executable file are interlocked with the open market by calling an API for registering and managing external open markets.

10. A server for managing a metastore, comprising:
(a) a static resource and metadata registering part for registering static resource and metadata at a metastore to produce a certain application by using open device APIs and external HTML5 authoring tools; and
(b) a target executable file creating part for checking a degree of matching between i) the static resource and the metadata and ii) information on parameters delivered from a build target metarepository by referring to a build target operating system and a build target platform if being configured, calling an external open build system and an API, creating and receiving a target executable file in return to fit for the configured build target operating system and platform and then storing the target executable file, the static resource and the metadata in a metasource repository.

11. The server of claim 10, wherein the target executable file creating part checks the degree of matching by checking occurrence of any error between i) the static resource and the metadata and ii) the information on parameters delivered from the build target metarepository.

12. The server of claim 10, wherein, if the metadata is of a composite application, the target executable file creating part checks a degree of matching between the composite application and its seed application.

13. The server of claim 10, wherein, if another build target operating system and another build target platform are additionally configured other than the configured one, the target executable file creating part obtains the static resource and the metadata from the metasource repository.

14. The server of claim 10, wherein, the static resource is at least one of HTML, Image or JavaScript.

15. The server of claim 10, wherein the metadata is at least either XML or Json.

16. The server of claim 10, wherein the parameter information includes at least one piece of information on an app title, a method for creating an app, classification of an app build environment, an app version, explanation, keys to be used for each platform, an app package, a debug mode, and a download disclosure.

17. The server of claim 10, further comprising: a metadata creating part for creating a metadata for store corresponding to one of multiple open markets where the target executable file will be registered by matching required information between an open market metadata repository and a build metadatabase to check a condition to register in a market after the market is selected among multiple open markets.

18. The server of claim 17, further comprising: an interlock processing part for interlocking the created metadata for store and the target executable file with the open market by calling an API for registering and managing external open markets.

19. One or more computer-readable recording media having stored thereon a computer program that, when executed by one or more processors, causes the one or more processors to perform acts including:
(a) registering static resource and metadata at a metastore to produce a certain application by using an open device API and external HTML5 authoring tools;
(b) configuring a build target operating system and a build target platform;
(c) checking a degree of matching between i) the static resource and the metadata and ii) information on parameters delivered from a build target metarepository by referring to the configured build target operating system and platform;
(d) calling an external open build system and an API, if the degree of matching is satisfied, and then creating and receiving a target executable file in return to fit for the configured build target operating system and platform; and
(e) storing the target executable file, the static resource and the metadata in a metasource repository.
